(19) United States
(12) Patent Application Publication
(10) Pub. No.: US 2016/0214702 A1
(43) Pub. Date: Jul. 28, 2016

(54) HELICOPTER CABIN

(71) Applicant: Marenco Swisshelicopter AG, Pfaffikon (CH)

(72) Inventor: Martin STUCKI, Pfaffikon (CH)

(21) Appl. No.: 15/007,491

(22) Filed: Jan. 27, 2016

(30) Foreign Application Priority Data
Jan. 28, 2015 (CH) 00102/15

(51) Int. Cl. B64C 1/18

(52) U.S. Cl. CPC B64C 1/18

(57) ABSTRACT

In a helicopter cabin that can be fastened to a fuselage structure of a helicopter, encompassing a cabin floor surface, which extends from a front area to a rear area of the helicopter cabin, with front seats and pilot cabin doors arranged in the front area, and the pilot cabin doors along with a front surface and additional walls include part of an outer hull of the helicopter cabin that envelops the cabin floor surface, the comfort is to be enhanced on the ground and during flight. This is accomplished by virtue of the fact that the cabin floor surface of the helicopter cabin exhibits a cutout with a cutout depth directed toward the longitudinal axis in the area of the front seats tapered in the direction of the longitudinal axis.

### TECHNICAL AREA

The present invention describes a helicopter cabin that can be fastened to a fuselage structure of a helicopter, encompassing a cabin floor surface, which extends from a front area to a rear area of the helicopter cabin, wherein front seats and pilot cabin doors are arranged in the front area, and the pilot cabin doors along with a front surface and additional walls comprise part of an outer hull of the helicopter cabin that envelops the cabin floor surface.

### PRIOR ART

In recent years, helicopters or choppers have undergone technical improvements in some areas, wherein the focus was as a rule placed on the drive and control technology, as well as on improving the flight properties by intercepting asymmetrical forces on the rotor head.

Helicopters exhibit varyingly designed fuselage structures and configurations of the helicopter cabin fastened to the fuselage structure. The fuselage structure and helicopter cabin are fastened on a landing skid, spaced apart from the floor. The landing skids can here be designed either as a skid landing gear, or as a frame with wheels. As a rule, the helicopter cabin of the likely smaller and more maneuverable helicopter of interest here exhibits a respective pivoting pilot door and copilot door. These cabin doors are partially glazed, so that the pilots also have a lateral view out of the helicopter cabin during flight.

The currently known cabin doors in the area of the pilot and copilot seat allow pilots or individuals to enter the helicopter cabin in the front area. Exposed to very limited space conditions, a pilot here moves hand over hand from the landing skid or a footboard on the landing skid as a step and into his or her assigned pilot seat. As an example, FIG. 1 provides a view into a helicopter cabin according to EP2492189 of the applicant. The depicted arrow denotes the entry path that takes the pilot from a footboard on the landing skid to the cabin floor surface of the fuselage structure in the helicopter cabin.

No measures have yet been introduced to improve entry and egress in these kinds of helicopters. This situation for the pilot or copilot has thus far been varied within narrow limits, for example by changing the height of the landing skid, and hence by changing the distance between the cabin floor and the ground below. In practice, however, getting in and out is still not all that comfortable, since one has to remain steeply bent over while stepping through the door opening in the helicopter cabin until reaching the pilot seat. Since it has thus far been virtually impossible to reach into the cabin interior, an individual must as a rule sit down on one of the pilot seats to adjust the onboard electronics or check the parameters.

### DESCRIPTION OF THE INVENTION

The objective set by the applicant was to manufacture a helicopter cabin for a small, maneuverable and above all versatile helicopter in the so-called lightweight class that offers an enhanced comfort.

For this purpose, a way was found to make entry and egress possibilities more comfortable with the helicopter sitting on the ground. This is accomplished by a special configuration of the cabin floor or cabin floor surface.

In addition to optimizing entry and egress, the design of the front cabin doors, and hence the pilot cabin doors, can be correspondingly adjusted to also improve visibility, which is advantageous in flight while performing low-load operations.

### BRIEF DESCRIPTION OF THE DRAWINGS

Additional features, details and advantages of the invention may be gleaned from the following description of preferred embodiments of the invention as well as the drawings. Shown on:

FIG. 1 is a perspective view of a helicopter cabin of a helicopter according to prior art with the pilot seat door and roof omitted.

FIG. 2 is a side view of a helicopter from the copilot side with closed copilot seat door and rear sliding door, wherein the rear rotor is not depicted.

FIG. 3 is a sectional view of a helicopter cabin along the A-A line according to FIG. 2, wherein the pilot seat doors are open on both sides. The rear sliding doors in the rear area of the helicopter cabin are also open to provide a better illustration.

FIG. 4 is a perspective view of a helicopter cabin from the rear area to the front area from the pilot side, wherein the pilot seat door is open.

FIG. 5 is a side view of the helicopter cabin according to FIG. 4 from the copilot side.

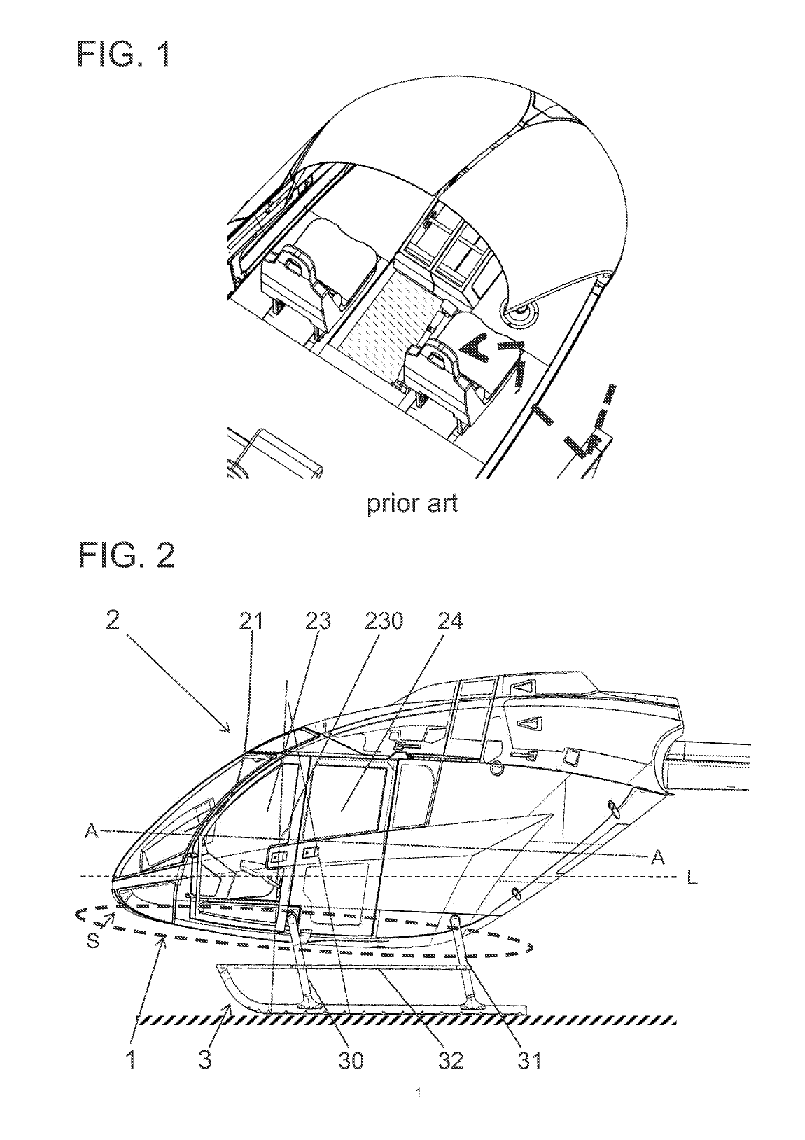

### DESCRIPTION

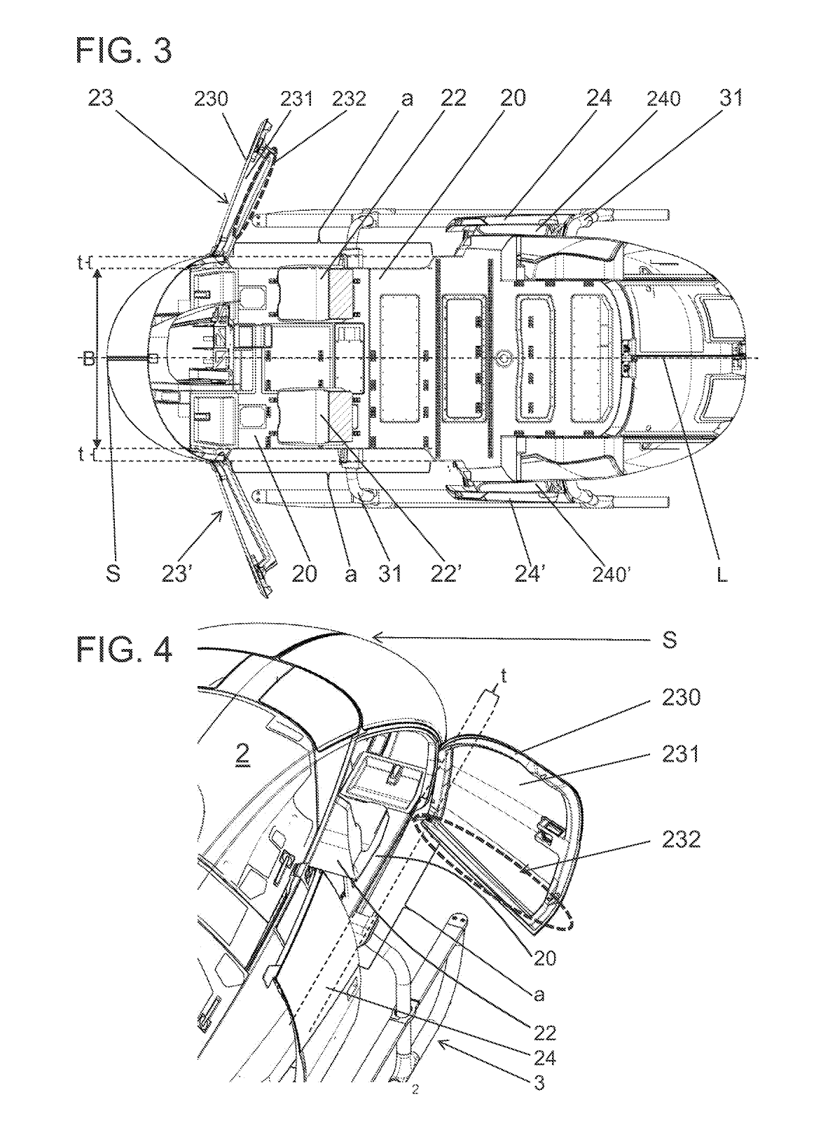

FIGS. 2 to 5 show a respective helicopter cabin 2 of a helicopter or parts of the helicopter cabin 2 in detail, since the invention relates to the configuration of the helicopter cabin 2 or parts of the helicopter cabin 2. This helicopter cabin 2 is part of a small, maneuverable and above all versatile helicopter in the so-called lightweight class.

The helicopter cabin 2 is joined with a fuselage structure 1, on which parts of the helicopter cabin 2 are mounted, and which is concealed by parts of the helicopter cabin 2. A landing skid 3 adjoins the fuselage structure 1. The landing skid 3 is here designed as a skid landing gear 30, which consists of several landing gear skid tubes 31, and additionally exhibits a floorboard 32. When at rest, the skid landing gear 30 and its landing gear skid tubes 31 are situated on the ground below, and the helicopter cabin 2 is spaced a distance apart from the ground below.

The helicopter cabin 2 extends from a front area with a peak S up to a rear area, which is adjoined by the structure for a rear rotor (not shown). Located in the front area of the helicopter cabin 2 is a cockpit input panel 21, which can be operated by a pilot or copilot. The outer hull of the helicopter cabin 2 exhibits pilot cabin doors 23 in the front area, which are designed as hinged or swinging doors, and each exhibit a door frame 230 and at least a partial glazing. A cargo hold sliding door 24 is arranged on at least one side of the rear area of the helicopter cabin 2. In conjunction with a front surface that is transparent over the largest possible surface and walls in the rear area, the doors 23, 24 form part of the outer hull of the helicopter cabin 2, which envelops the cabin interior.

The sectional view through the helicopter cabin 2 along the sectional line A-A from FIG. 2 depicts a helicopter cabin 2 with open pilot cabin doors 23, 23′ as the pilot cabin door 23 and copilot cabin door 23′. These pilot cabin doors 23 are located in the front area of the helicopter cabin 2, while the open cargo hold sliding doors 24, 24′ are located in the rear area of the helicopter cabin 2. Front seats 22 are arranged in the front area at the height of the pilot cabin doors 23, 23′ as the pilot seat 22 and copilot seat 22′.

The helicopter cabin 2 exhibits a cabin floor surface 20, which covers the entire cabin interior up to the fuselage structure 1. The cabin floor surface 20 here exhibits a changing width that progresses from the rear area to the front area. The cabin floor surface 20 is here tapered in a direction perpendicular to the longitudinal axis L of the helicopter cabin. A cutout a through which the tapering of the cabin floor surface 20 is achieved extends from the front area up to the rear area. The resultant width B from the edges of the cabin floor surface 20 in the tapered area is smaller than the width in the rear area and/or in the front area of the helicopter cabin 2. If at all possible, the resulting width B extends between the outer edges of the pilot seats 23, 23′. A cutout depth t measuring on the order of greater than eight centimeters can be defined. The maximum possible cutout a is limited by the positioning of the front seats 22, 22′, so as to ensure a sufficiently stable cabin floor surface 20.

An increased distance between the edge of the cabin floor surface 20 and the landing gear skid tubes 31 of the skid landing gear 3 is achieved by the configuration of cutout a. If the helicopter cabin 2 is only to be accessible from one side, the cutout a is correspondingly arranged only on the pilot or copilot side.

In a preferred embodiment, the pilot cabin doors 23 also exhibit a convexly shaped door frame 230, as well as a convex, transparent door surface 231. In a floor section 232 of the pilot cabin doors 23, the door surface 231 and door frame 230 are convexly shaped in such a way that the floor section 232 can project partially over the cutout a with the pilot cabin door 23 closed. In the closed position, the floor section 232 is convexly guided at least partially underneath the cabin floor surface 20 up until the fuselage structure 1. The convex and transparently designed floor section 232 thus at least partially covers the cutout a in the closed position. In the open position, access to the cabin floor surface 20 is facilitated by the tapering in the area of the front seats 22.

The cargo hold sliding doors 24, 24′ can also exhibit a convex floor section 240, 240′, which optionally can also have a transparent design. In addition to facilitating access to a helicopter cabin 2 located on the ground, an improved downward view during flight can also be achieved here as well.

The perspective view of and in a helicopter cabin 2 shown on FIG. 4 once again illustrates the space gained by recessing the cutout a at the height of the pilot cabin doors 23. The convex floor section 232 of the pilot cabin door 23 denoted by the dashed ellipsis completely releases the cutout a with the pilot cabin door 23 open. The pilot can enter more easily, and get directly to the pilot seat 22, since the cabin floor surface 20 is cut out nearly to the pilot seat 22, and thus tapers toward the front area. The arrangement of the cutout a also allows the pilot to move between the skid landing gear 3 or floorboard 32 and cabin floor surface 20, and reach into the cabin interior to check the electronics or settings, without absolutely having to get in. Of course, the same also holds true for the copilot side, wherein a cutout a is arranged in the cabin floor surface 20.

Depending on the length of the cutout a, cargo hold entry and egress can also be facilitated by the cargo hold sliding door 24 due to the tapered cabin floor surface 20.

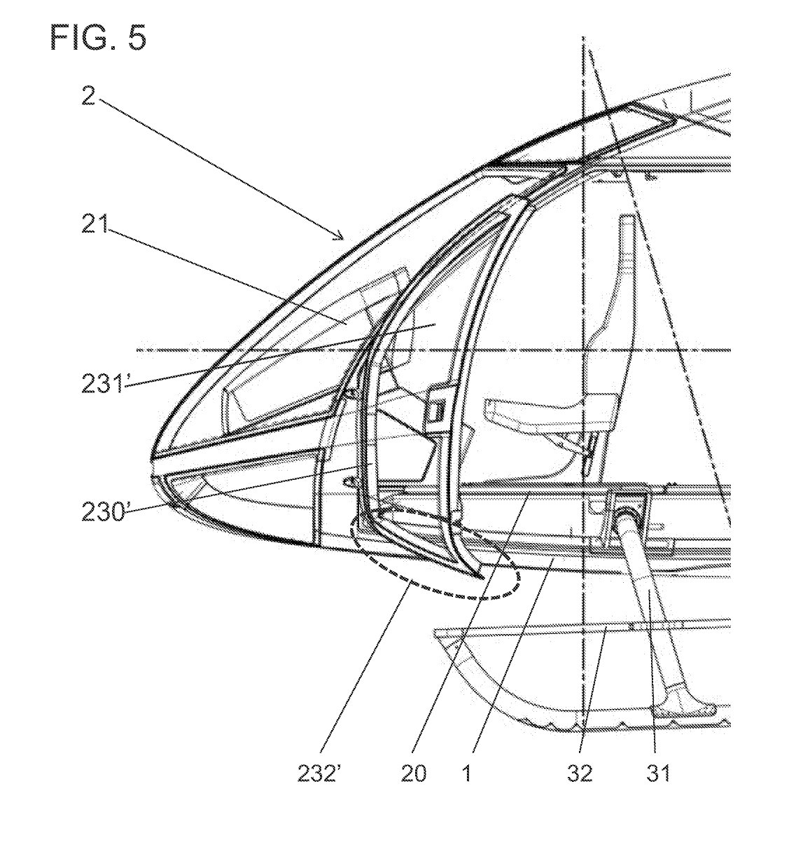

Discernible in the partial view of the helicopter cabin 2 according to FIG. 5 is a windshield or preferably the entire front area of the helicopter cabin 2, which is transparent over as large a surface as possible, which is intended to yield an optimal view. If the cabin surface 20 is configured with a cutout a, and hence a tapering, and a transparent, convex floor section 232′ is additionally situated in the pilot cabin door 23, 23′, the view can be further improved with the pilot cabin door 23′ closed. The convex floor section 232′ is fitted to the pilot cabin door 23′ in such a way that this floor section 232′ seals off the cabin interior underneath the cabin surface 20 with the pilot cabin door closed 23′.

With the pilot cabin door 23′ closed, the pilot or copilot can look through the cutout a in the cabin surface 20 and fuselage structure 1 under the helicopter cabin 2, which is advantageous when performing low-load operations. The fuselage structure 1 must be correspondingly designed, and allow a view through the pilot cabin door 23′.

In order to ensure an optimized lateral view, the convex, transparent door surface 231, 231′ along with the cargo hold sliding door 24 can be completely transparent in design, and not just in the area of the floor section 232, 232′, 240.

Nearly completely transparent door surfaces 231 can be fabricated with the currently available modern materials, such as acrylic sheet or Plexiglas, in conjunction with tailored shapes for the door frames 230.

The configuration according to the invention of the helicopter cabin 2 or fuselage structure 1, as well as of the pilot cabin doors 23, 23′, can also be used for mixed forms of airplanes and rotorcraft or gyrocopters in which the pilot and copilot gain entrance through the corresponding pilot cabin doors 23, 23′.

### REFERENCE LIST

1 Fuselage structure
2 Helicopter cabin (on fuselage structure)
S Peak
L Longitudinal axis
20 Cabin floor surface
a Cutout/tapering
t Cutout depth
B Resulting width
21 Cockpit input panel
22 Front seats (pilot seat, copilot seat)
23 Pilot cabin door
230 Door frame
231 Convex, transparent door surface
232 Floor section, convex/transparent
24 Cargo hold floor section (transparent)
240 Convex floor section (transparent)
3 Landing skid
30 Skid landing gear
31 Landing gear skid tube
32 Floorboard

1. A helicopter cabin that can be fastened to a fuselage structure of a helicopter,
encompassing a cabin floor surface, which extends from a front area to a rear area of the helicopter cabin, wherein front seats and pilot cabin doors are arranged in the front area, and the pilot cabin doors along with a front surface and additional walls comprise part of an outer hull of the helicopter cabin that envelops the cabin floor surface,
wherein
the cabin floor surface of the helicopter cabin exhibits a cutout with a cutout depth directed toward the longitudinal axis in the area of the front seats tapered in the direction of the longitudinal axis.

2. The helicopter cabin according to claim 1, wherein the cutout depth of the cutout projects up to the outer edges of the pilot seats, so that a resultant width in the tapered area is smaller than the width of the cabin floor surface in the front area and/or in the rear area at the widest location.

3. The helicopter cabin according to claim 1, wherein the cutout in the cabin floor surface extends in the direction parallel to the longitudinal axis until into the rear area, and hence into the area of the cargo hold sliding door.

4. The helicopter cabin according to claim 3, wherein the cutout depth measures at least 8 cm.

5. The helicopter cabin according to claim 1, wherein a floor section of the pilot cabin door facing the fuselage structure is transparent and convex in design, so that the cutout in the cabin floor surface is at least partially covered by the floor section with the pilot cabin door closed.

6. The helicopter cabin according to claim 5, wherein the convex, transparent floor section projects at least partially under the cabin floor surface in the closed state of the pilot cabin door.

7. The helicopter cabin according to claim 3, wherein a floor section of the cargo hold sliding door facing the fuselage structure is transparent and convex in design, so that the cutout in the cabin floor surface is covered at least partially by the floor section in the rear area with the cargo hold sliding door closed.

8. The helicopter cabin according to claim 7, wherein the convex, transparent floor section projects at least partially under the cabin floor surface in the closed state of the cargo hold sliding door.
